(19) United States
(12) Patent Application Publication
(10) Pub. No.: US 2020/0220155 A1
(43) Pub. Date: Jul. 9, 2020

(54) POLYANILINE AND GRAPHENE BASED NANOCOMPOSITE MATERIALS FOR CATHODES OF RECHARGEABLE BATTERIES AND METHOD FOR MANUFACTURING THE SAME

(71) Applicant: Oleg Yuliyovych POSUDIIEVSKYI, Kyiv (UA)

(72) Inventor: Oleg Yuliyovych POSUDIIEVSKYI, Kyiv (UA)

(21) Appl. No.: 16/628,673

(22) PCT Filed: Jul. 6, 2018
(86) PCT No.: PCT/IB2018/055009

§ 371 Date: Jan. 5, 2020

(30) Foreign Application Priority Data
Jul. 7, 2017 (UA) A 2017 07173

(51) Int. Cl. H01M 4/133; H01M 10/0525; H01M 10/36; H01M 4/04; H01M 4/36; H01M 4/60

(52) U.S. Cl. CPC H01M 4/133; H01M 10/0525; H01M 10/36; B82Y 30/00; H01M 4/049; H01M 4/364; H01M 4/606; H01M 4/0471

(57) ABSTRACT

A hybrid nanocomposite useful as a cathode in high discharge capacity rechargeable batteries is provided. The nanocomposite includes polyaniline macromolecules in the state of emeraldine base that are located between 2D particles of nanostructured graphite or few-layered graphene. The nanocomposite possesses high charge/discharge characteristics. A solvent-free mechanochemical method for the preparation of the hybrid nanocomposites is also provided.

### TECHNICAL FIELD

The present invention relates to conducting polymer based nanocomposites as an active component of a rechargeable battery cathode and methods for manufacturing the nanocomposites.

### BACKGROUND ART

Rechargeable batteries, lithium, sodium, potassium or magnesium batteries or corresponding metal-ion batteries in particular, are energy storage and production devices capable of being charged and discharged. Such batteries are widely used as autonomous power sources for various portable electronic devices (e.g., cellular phones, cameras, audio players, laptop computers, and the like.), as well as for electric and hybrid vehicles, energy grid systems, and other applications. The development of batteries that are lightweight and have higher charge/discharge capacity is an important issue of autonomous energetics.

A typical rechargeable battery, lithium battery in particular, includes a cathode, an electrolyte and an anode. The charge/discharge characteristics of cathode materials are important factors in determining the capacity for energy storage. Crystalline oxides based on cobalt, manganese, nickel and vanadium are the most studied materials for the cathode materials in lithium batteries. Commercialized LiCoO2 has high redox potential along with long term stability. However, such materials tend to be costly and toxic while also having a low charge/discharge capacity. LiMn2O4 has been considered as an alternative to conventional LiCoO2 because of its sufficiently high redox potential and associated low cost. However, this material also suffers from a low charge/discharge capacity and long term stability at cycling. Although LiNiO2 is another potential cathode material because of its theoretically better discharge capacity than LiCoO2, this material presents significant difficulty with respect to its preparation. For the case of V2O5, there is a disadvantage with respect to the stability of the material at charge/discharge cycling. Therefore, there is an urgent demand in creation of a new electrode material to overcome the shortcomings of the known crystalline transition metal oxides.

Conducting conjugated polymers can be an alternative to transition metal oxides. In particular, the known polymer material is polyaniline (PANI), which due to the system of conjugated bonds is redox active and because of the doping effect can be electrically conducting and capable of reversible electrochemical transitions, which makes it possible to use PANI as an active component of lithium batteries cathodes.

Usually, PANI is prepared chemically or electrochemically.

It is known that the chemically synthesized PANI doped with HCl is characterized by a specific discharge capacity of ˜20 mAh/g, which is ˜14% of the theoretically possible capacity at 50% doping degree of the polymer macromolecules [K. S. Ryu, K. M. Kim, S.-G. Kang, J. Joo, S. H. Chang. Comparison of lithium//polyaniline secondary batteries with different dopants of HCl and lithium ionic salts. Journal of Power Sources, 2000, vol. 88, p. 197-201], and chemically synthesized PANi re-doped with lithium salts after its dedoping by treatment with NH4OH can have a specific discharge capacity of ˜100 mA h g−1, which is ˜70% of the mentioned theoretically possible capacity [K. S. Ryu, Y.-S. Hong, Y. J. Park, X. Wu, K. M. Kim, Y.-G. Lee, S. H. Chang, S. J. Lee. Polyaniline doped with dimethyl sulfate as a polymer electrode for all solid-state power source system. Solid State Ionics, 2004, vol. 175, p. 759-763].

It is also known that electrochemically synthesized PANI is characterized by a specific discharge capacity of ˜100 mA h g-1 [H. Daifuku, T. Fuse, M. Ogawa, Y. Masuda, S. Toyosawa, R. Fujio. Electric cells utilizing polyaniline as a positive electrode active material. U.S. Pat. No. 4,717,634, 1988]. At the same time, it was shown in [O. Yu. Posudievsky, O. A. Kozarenko, V. S. Dyadyun, V. G. Koshechko, V. D. Pokhodenko. Method for obtaining material for a cathode of lithium batteries based on mechanochemically obtained polyaniline. Ukraine Patent, 111352, 2016] that mechanochemically prepared PANI doped with lithium salts can have a specific discharge capacity of ˜146 mA h g-1, which is ˜100% of the mentioned theoretically possible capacity at 50% doping degree of the polymer macromolecules.

However, such values of specific discharge capacity of PANI are insufficient for the manufacture of high-performance cathodes for lithium batteries.

Accordingly, there is a need for creation of novel cathode materials with improved functional performance for rechargeable batteries, in particular, lithium batteries applications.

### SUMMARY OF INVENTION

The present invention solves one or more problems of the prior art by providing in one embodiment a hybrid nanocomposite that is useful as a cathode in high discharge capacity rechargeable batteries, in particular, lithium batteries. The nanocomposite of this embodiment includes conducting polymer PANI and nanostructured graphite or few-layered graphene (Gr).

In another embodiment, a method for forming a hybrid two-component nanocomposite comprising a conducting conjugated polymer PANI and nanostructured graphite or few-layered graphene (PANI/Gr) is provided. The method of this embodiment comprises combining chemically or mechanochemically synthesized PANI in the state of emeraldine base and few-layered graphene prepared by mechanochemical treatment of a mixture of graphite microflakes and chemically inert substrate with hardness, which is superior than that of graphite, and subsequent removal of this substrate by solvent, with formation of a mixture that is then mechanically agitated to form the hybrid nanocomposite. This latter step is a mechanochemical treatment step. Advantageously, the mechanochemical treatment step is solvent-free.

In still another embodiment of the present invention, a method for forming a hybrid two-component nanocomposite PANI/Gr is provided. The first stage of this embodiment comprises combining graphite micro-flakes and chemically inert substrate with hardness, which is superior than that of graphite, with formation of a primary mixture which is mechanochemically treated resulting in an intermediate nanocomposite consisted from nanometer and micrometer sized particles of the chemically inert substrate with an outer surface covered by a layer of Gr. During the second stage, a new mixture is prepared by adding chemically synthesized PANI in the state of emeraldine base to this intermediate nanocomposite, which is then subjected to the mechanochemical treatment with formation of the hybrid nanocomposite in result of removal of the chemically inert substrate by washing using a solvent and drying. Advantageously, the mechanochemical treatment step is solvent-free.

PANI/Gr nanocomposites are advantageously prepared by effective and environmentally friendly mechanochemical methods. Moreover, these nanocomposites possess improved charge/discharge performance in comparison with the known prior art analogues. Accordingly, these nanocomposites can be used for creation of high discharge capacity-required rechargeable batteries, lithium batteries in particular.

### BRIEF DESCRIPTION OF DRAWINGS

Exemplary embodiments of the present invention will become more fully understood from the detailed description and the accompanying drawings, wherein:

FIG. 1

Shown a schematic cross section of a rechargeable battery, lithium battery in particular, using a hybrid nanocomposite.

FIG. 2

Shown the variation of specific discharge capacity with the number of cycles of the as-prepared mechanochemically treated PANI (mt-PANI) described in Example 4. The capacity was calculated on the basis of PANI content in the cathode mass. Charge and discharge currents are equal and shown in the graph.

FIG. 3

Shown the variation of specific discharge capacity with the number of charge-discharge cycles for PANI in PANI/Gr nanocomposite described in Example 5. The capacity was calculated on the basis of PANI content in the cathode mass. Charge current is equal to C/6 and the value of the discharge current is shown in the graph.

FIG. 4

Shown the variation of specific discharge capacity with the number of charge-discharge cycles for PANI in PANI@Gr nanocomposite described in Example 6. The capacity was calculated on the basis of PANI content in the cathode mass. Charge current is equal to C/6 and the value of the discharge current is shown in the graph.

### DESCRIPTION OF EMBODIMENTS

### Detailed Description of Exemplary Embodiments

Reference will now be made in detail to presently preferred compositions, embodiments and methods of the present invention, which constitute the best modes of practicing the invention presently known to the inventor. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of component.

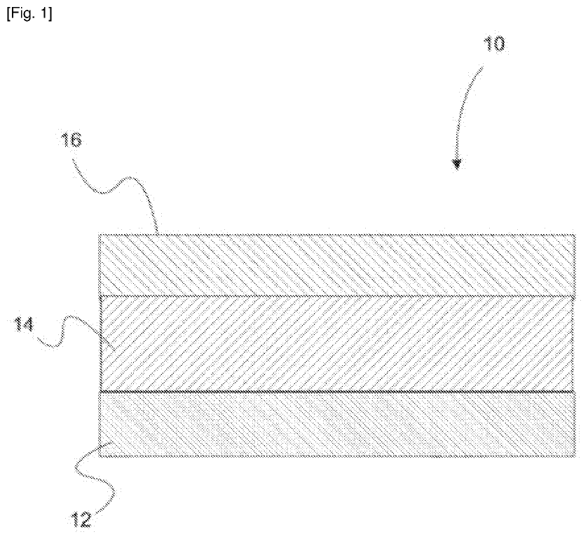

With reference to FIG. 1, a schematic cross section of a rechargeable battery using a hybrid nanocomposite is provided. Rechargeable battery 10 includes anode layer 12, electrolyte layer 14, and cathode layer 16. Advantageously, anode layer 12 includes lithium, sodium or potassium. Advantageously, cathode layer 16 includes the hybrid nanocomposites set forth below in more detail. For example, a composite of polyaniline with nanostructured graphite or few-layered graphene (PANI/Gr).

In an embodiment of the present invention, a hybrid nanocomposite that is useful as a battery cathode material is provided. The nanocomposite of this embodiment includes PANI and Gr. In one variation, the nanocomposite is a two-component hybrid organic-inorganic nanocomposite. In another variation, the nanocomposite is a three-component hybrid organic-inorganic nanocomposite. The composites of the present embodiments consist of PANI macromolecules treated mechanochemically in the presence of Gr which is represented by graphite particles with lateral size from 100 till 1000 nm, advantageously from 200 till 500 nm, and thickness from one till twenty graphene layers, advantageously from one till five graphene layers.

In another embodiment of the present invention, a method of forming the nanocomposite PANI/Gr set forth above is provided. The method of this embodiment includes a step of forming a mixture comprising PANI and Gr, which is subsequently subjected to a mechanochemical treatment in which the mixture is mechanically agitated. In a refinement, a predetermined amount of milling media is added to the reaction mixture prior to mechanochemical treatment. That media depends on equipment used for milling, which can be easily determined by one skilled in the art or found in documentation of the equipment producer.

The mixture is then agitated in the mechanochemical treatment step to form the hybrid nanocomposite. In a refinement, the mechanochemical treatment step is solvent-free. In one variation, PANI is present in an amount from about 75 to about 99 weight percent of the total weight of the reaction mixture. In another variation, Gr in an amount from about 1 to about 25 weight percent of the total weight of the reaction mixture.

Scientific and patent literature contains information on a range of materials based on PANI or Gr, but production of such hybrid nanocomposites by a mechanochemical method without the use of any toxic inorganic and/or organic solvent that can provide nanocomposites with new functional properties, as well as solve environmental issues of preparing such materials, was never discussed.

The method of this embodiment includes a step of forming a mixture of PANI in the state of emeraldine base and Gr and its subsequent mechanochemical treatment. A predetermined amount of milling media is added to the reaction mixture prior to mechanochemical treatment. Gr consists of nanoparticles which have nanometer thickness and layered structure. It can be prepared by mechanochemical treatment of bulk graphite (graphite micro-flakes, in particular) in the presence of the chemically inert substance (inorganic salt, in particular) superior to graphite in hardness and subsequent removal of this substance by washing with a solvent (water, in particular). NaCl, KCl, KBr, Na2SO4, K2SO4, MgSO4, etc. can be the samples of such salts.

In another embodiment of the present invention, a change of the sequence of operations necessary for preparing nanocomposites based on PANI in the state of emeraldine base and Gr is possible. Initially, similar to the previous embodiment, a mixture of bulk graphite in the presence of a chemically inert substance is mechanochemically treated. Then, PANI in the state of emeraldine base is added to this mixture and the subsequent mechanochemical treatment is performed, after which the chemically inert substance is removed from the prepared product by washing with water.

The mixture with milling media is subject to mechanochemical treatment for activating further exfoliation of Gr in the polymer matrix. Mechanochemical treatment is preferably carried out under room conditions, usually at a temperature of from 15° C. to 40° C., which meet the technical conditions for the use of equipment used for mechanochemical treatment. A hybrid nanocomposite is formed during the mechanochemical treatment.

The term “mechanochemical treatment” as used herein means “mechanochemical synthesis”, “mechanochemical activation”, “mechanochemical milling”, and related processes. The term “mechanochemical treatment” includes such processes, in which mechanical energy is used to activate, initiate or promote chemical reactions, crystal structure transformations or phase change in a material or mixture of materials. The term “mechanochemical treatment” as used herein means agitation in the presence of a milling media to transfer mechanical energy to the mixture. The mixture can be contained in a closed vessel or chamber. The term “agitating” or “agitation” as used herein shall include applying at least one, or any combination of two or more of the fundamental kinematic motions including translation (e.g., side-to-side shaking), rotation (e.g., spinning or rotating) and inversion (e.g., end-over-end tumbling) to the mixture. In a useful variation, all three motions are applied to the mixture. It should be appreciated that such agitation can be accomplished with or without external stirring of the reaction mixture and milling media.

In a variation of the mechanochemical treatment step, a mixture of reactant powders is combined in suitable proportions with milling media in a vessel or chamber that is mechanically agitated (i.e., with or without stirring) for a predetermined period of time at a predetermined intensity of agitation. In another variation of the mechanochemical treatment step, the reaction mixture is mechanically agitated (i.e., with or without stirring) for a predetermined period of time at a predetermined intensity of agitation under nominally ambient conditions in the absence of added liquids or organic solvents.

In still another variation of the method of forming the nanocomposites, a predetermined amount of milling media, preferably chemically-inert, rigid milling media, is added to a dry reaction mixture comprising PANI in the state of emeraldine base as an organic component and Gr prior to mechanochemical treatment. Typically, the weight ratio of reaction mixture to milling media can range from about 1:7 to 1:40. The reaction mixture is subjected to mechanochemical treatment, for example, in a milling apparatus whereby the reaction mixture is agitated in the presence of milling media at ambient temperature (i.e., without the need for external heating). The term “chemically-inert” milling media as used herein means that the milling medium does not react chemically with any of the components of the reaction mixture. The rigid milling media advantageously comprises various materials such as natural minerals, ceramics, glass, metal or high-strength polymeric compositions, in a particulate form. Preferred ceramic materials, for example, can be selected from a wide array of ceramics desirably having sufficient hardness and friability to enable them to avoid being chipped or crushed during milling and also having sufficiently high density. Suitable densities for milling media are from about 3 to 15 g/cm3. Examples of ceramic materials include, but are not limited to, agate, aluminum oxide, zirconium oxide, zirconia-silica, yttria-stabilized zirconium oxide, magnesia-stabilized zirconium oxide, silicon nitride, silicon carbide, cobalt-stabilized tungsten carbide and the like, and combinations thereof. In a refinement, the glass milling media are spherical (e.g., beads), have a narrow size distribution, and are durable. Suitable metal milling media are typically spherical and generally have good hardness (i.e., Rockwell hardness RHC 60-70), extreme roundness, high wear resistance, and narrow size distribution. Metal milling media include, for example, balls fabricated from type 52100 chrome steel, type 316 or 440C stainless steel or type 1065 high carbon steel.

In a variation of the present embodiment, the mechanochemical treatment is accomplished by a milling apparatus that applies compressive forces and shear stress to the particles of the reaction mixture over a prolonged time. A suitable apparatus for accomplishment of the mechanochemical treatment of the present invention is a planetary ball mill, for example Pulverizette 6 available commercially from Fritsch.

Although the embodiments of the present invention are not limited to any particular theory of operation, it is believed that during the mechanochemical treatment of the reaction mixture, the impact of the milling media with particles of PANI and Gr can result in the change of the organic molecules conformation. It is further theorized that because of the layered structure of the Gr particles, their thickness can be decreased due to shear stress induced by the mechanochemical treatment. It is also appreciated that conformation change and thickness decrease can take place simultaneously.

It is also theorized that the mechanochemical treatment of the mixture consisting of PANI and the chemically-inert delamination substance particles covered with a layer of Gr can lead to analogous changes, and subsequent removal of the particles of the chemically-inert delamination substance by washing using a solvent allows one to obtain PANI/Gr nanocomposites with increased porosity.

Mechanochemical treatment of the mixture of PANI and Gr for an inadequate period of time (e.g., less than about 60 minutes) can result in non-homogeneity of the as prepared nanocomposite that can result in insufficiently high discharge characteristics of the obtained material. Prolonged mechanochemical treatment (e.g., >24 hours) is also undesirable since the hybrid nanocomposite becomes highly amorphous and also exhibits poor discharge performance.

The following examples illustrate the various embodiments of the present invention. Those skilled in the art will recognize many variations that are within the spirit of the present invention and scope of the claims.

As starting materials for preparing of PANI/Gr hybrid nanocomposites, chemically synthesized PANI in the state of emeraldine basis and nanostructured graphite or few layered graphene (Gr) or NaCl crystals coated with a layer of nanostructured graphite or few-layered graphene (NaCl@Gr) were used.

### EXAMPLES

### Example 1

Preparation of Nanostructured Graphite or Few-Layered Graphene (Gr)

Gr is prepared by combining 50 mg of graphite micro-flakes and 2 g of NaCl together with 30 agate balls with diameter of 10 mm in an 80 mL grinding bowl. The weight ratio of reactants to milling media is about 1:22. The mixture is mechanochemically treated using a planetary ball mill Pulverizette 6 at an agitation speed of 500 rpm for a period of 1 hour. The product in the form of NaCl@Gr powder is separated from milling media by dry sieving. Gr is prepared by removal of NaCl using twice-distilled water up to full dissolution and extraction of NaCl and final drying of the obtained material at 120□C.

### Example 2

Preparation of NaCl Crystals Coated with a Nanostructured Graphite or Few-Layered Graphene (NaCl@Gr)

NaCl@Gr is prepared by combining 50 mg of graphite micro-flakes and 2 g of NaCl together with 30 agate balls with diameter of 10 mm in an 80 mL grinding bowl. The weight ratio of reactants to milling media is about 1:22. The mixture is mechanochemically treated using a planetary ball mill Pulverizette 6 at an agitation speed of 500 rpm for a period of 1 hour. The product in the form of NaCl@Gr powder is separated from milling media by dry sieving.

### Example 3

Preparation of PANI in the State of Emeraldine Base

The doped PANI is synthesized by chemical polymerization of aniline in an 1M aqueous hydrochloric acid solution under the action of ammonium persulfate as an oxidizer. The molar monomer:oxidant ratio is 0.8. The polymerization time is 3 hours. Upon completion of the polymerization, the product is separated on the filter and washed thoroughly with ethanol and water. It is then treated with 3% aqueous ammonia for dedoping and transfer of PANI in the state of emeraldine base, purified by 20-fold extraction with acetonitrile in a Soxhlet apparatus and dried in vacuum.

### Example 4

Preparation of Mechanochemically Treated PANI (Mt-PANI)

mt-PANI is prepared by combining a dry powder of PANI in the state of emeraldine base, prepared as in Sample 3, and 30 agate balls with diameter of 10 mm as milling media in an 80 mL grinding bowl. The weight ratio of PANI in the state of emeraldine base to milling media is about 1:22. The mixture is mechanochemically treated using a planetary ball mill Pulverizette 6 at an agitation speed of 300 rpm for a period of 1 hour. The product in the form of mt-PANI powder is separated from milling media by dry sieving.

### Example 5

Preparation of PANI/Gr Hybrid Nanocomposite

PANI/Gr nanocomposite is prepared by combining 1.8 mg of PANI in the state of emeraldine base, prepared as in Sample 3, and 0.2 g of Gr, prepared as in Sample 1, and 30 agate balls with diameter of 10 mm as milling media in an 80 mL grinding bowl. The mixture is mechanochemically treated using a planetary ball mill Pulverizette 6 at an agitation speed of 300 rpm for a period of 1 hour. The product—PANI/Gr nanocomposite—is separated from milling media by dry sieving.

### Example 6

Preparation of PANI@Gr Hybrid Nanocomposite

PANI@Gr nanocomposite is prepared by combining 0.45 g of PANI in the state of emeraldine base, prepared as in Sample 3, and 2.05 g of NaCl@Gr, prepared as in Sample 2, and 30 agate balls with diameter of 10 mm as milling media in an 80 mL grinding bowl. The product is separated from milling media by dry sieving, washed with water to dissolute and remove of NaCl and vacuum dried at 60□C. The yield of PANI@Gr nanocomposite is 95%.

Discharge Characteristics of as-Prepared Samples

CR2032-type cells were assembled in the dry glove box for electrochemical measurements. In the case of mt-PANI, the mixture of the polymer, carbon black and the poly[(vinylidene fluoride)-co-hexafluoropropylene] (75:15:10 wt. %) was used as a cathode, metal foil, Li foil in particular, as a negative electrode and 1M solution of the corresponding salt, LiClO4 in particular, in ethylene carbonate/dimethyl carbonate (50:50 vol. %) as an electrolyte. In the case of PANI/Gr and PANI@Gr, the mixture of the nanocomposite and the poly[(vinylidene fluoride)-co-hexafluoropropylene] (90:10 wt. %) was used as a cathode. Charge-discharge cycling is performed in 2.0-4.2 B vs. Li/Li+ potential range.

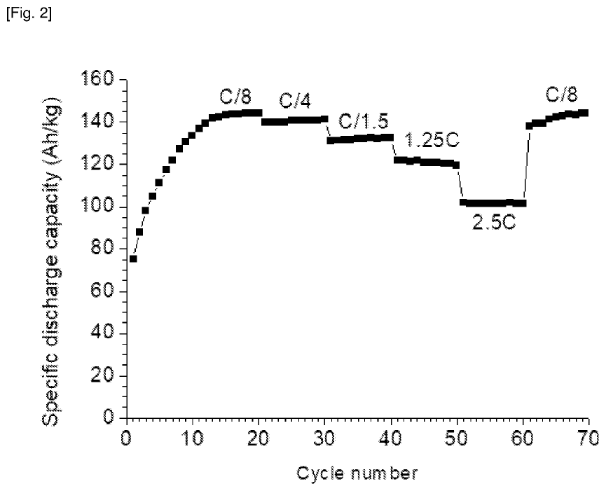

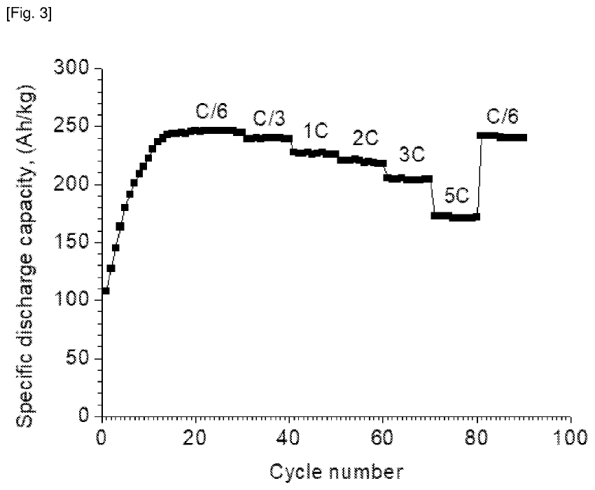

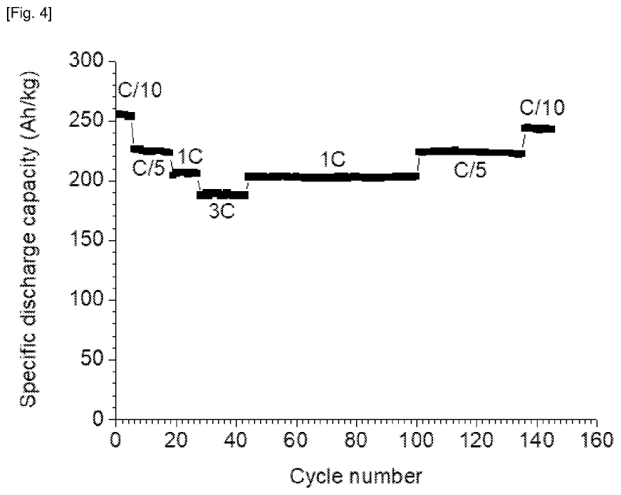

Variation of discharge capacity with respect to the number of charge-discharge cycles for the as-prepared materials is depicted in FIGS. 2-4. The discharge capacity of the as-prepared nanocomposites PANI/nGr (247 Ah/kg) essentially exceeds the discharge capacity of mt-PANI (144 Ah/kg) as the prototype. For PANI/Gr nanocomposite, the specific tendency in the change of capacity during cycling consisting in an increase of its value at increase of the number of charge-discharge cycles is observed.

Unlike mt-PANI and PANI/Gr, the cycling of PANI@Gr nanocomposite was not characterized by such tendency, since the maximum value of the specific discharge capacity was achieved in the first cycle. At the same time, the value of the specific capacity of PANI@Gr (256 Ah/kg) was somewhat higher than the capacity of PANI/Gr nanocomposite (247 Ah/kg), which it reached after 15 cycles of charge-discharge.

As described above, the new hybrid nanocomposites based on PANI and Gr as electrode materials are prepared in a new efficient and environmentally friendly manner. The presence of Gr in the composition of the nanocomposites changes the ability of PANI to redox transformations and provides a fundamental increase in the specific electrochemical capacity of the polymer within the nanocomposites. The nanocomposites have improved charge/discharge characteristics as compared with the individual polymer; so, they can be used for creation of rechargeable batteries, lithium, sodium, potassium or magnesium batteries or corresponding metal-ion batteries in particular, with higher discharge capacity.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A hybrid nanocomposite for cathodes of rechargeable batteries comprising: polyaniline in the state of emeraldine base;
nanostructured graphite or few-layered graphene consisting of particles with a lateral size from about 100 to 1000 nm and a thickness from about 1 to 20 layers;
wherein the nanocomposite is a two-component hybrid and the stated components are present in a relative amount from about 75:25 to 99:1 percent of the total weight of the hybrid nanocomposite.

2. The nanocomposite of claim 1 wherein the nanocomposite is a two-component hybrid comprising the stated components in a relative amount from about 85:15 to 95:5 percent of the total weight of the hybrid nanocomposite and graphene component consisting of particles with a lateral size from about 200 to 5000 nm and a thickness from about 1 to 5 layers.

3. A method for preparing a hybrid two-component nanocomposite for cathodes of rechargeable batteries comprising polyaniline and nanostructured graphite or few-layered graphene, the method comprising:
formation of a mixture of graphite and water-soluble chemically inert solid substance, inorganic salt in particular;
mechanochemical treatment of the mixture and separation of the nanocomposite comprising nanostructured graphite or few-layered graphene and water-soluble chemically inert solid substance by dry sieving;
removal of the stated chemically inert solid substance from the prepared nanocomposite by washing with water and subsequent drying of the resultant nanostructured graphite or few-layered graphene in vacuum at 60° C.;
formation of a reaction mixture combining polyaniline and nanostructured graphite or few-layered graphene; and
solvent-free mechanochemical treatment of the mixture.

4. The method of claim 3 wherein a reaction mixture combining polyaniline in the state of emeraldine base and the nanocomposite consisting from nanostructured graphite or few-layered graphene and water-soluble chemically inert solid substance, prepared in result of step b), is mechanochemically treated and the resultant hybrid two-component nanocomposite comprising polyaniline and nanostructured graphite or few-layered graphene is prepared by further separation of the prepared three-component nanocomposite consisting of polyaniline, nanostructured graphite or few-layered graphene and water-soluble chemically inert solid substance by dry sieving, removal of the stated chemically inert solid substance from it by washing with water and subsequent drying in vacuum at 60° C.

5. The method of claim 3, wherein the water-soluble chemically inert solid substance comprises a component selected from the group consisting of NaCI, KCI, KBr, Na2SO4, K2S04, MgS04.

6. The method of claim 3, wherein each step including mechanochemical treatment is substantially solvent-free.

7. The nanocomposites of claim 1, which can be used in cathodes of metal or metal-ion rechargeable batteries with metal or metal ion being lithium, sodium, potassium or magnesium.

8. Rechargeable batteries, in particular lithium, sodium, potassium or magnesium batteries or corresponding metal ion batteries, with a cathode based on a hybrid nanocomposite of claim 1.
